(19) United States
(12) Patent Application Publication
(10) Pub. No.: US 2008/0077468 A1
(43) Pub. Date: Mar. 27, 2008

(54) MANAGING RESPONSES TO EXTENDED INTERVIEWS TO ENABLE PROFILING OF MOBILE DEVICE USERS

(75) Inventor: Oliver M. Raskin, Portland, OR (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/463,859

(22) Filed: Aug. 10, 2006

(51) Int. Cl. G07G 1/00

(52) U.S. Cl. 705/10

(57) ABSTRACT

A mobile profiling engine is provided. The mobile profiling engine includes an interview manager which assembles an extended interview, and partitions the extended interview into a number of discrete response tasks. The users provide contact information, including time availability. The interview is administered to the user, through their internet or SMS-enabled mobile device, over multiple sessions or multiple transactions, scheduled based on the time availability indicated by the user.

### FIELD OF THE INVENTION

The present invention relates generally to communicating messages over a network, and in particular but not exclusively, to an apparatus, method, and manufacture for assembling and sending discrete response tasks from an extended interview to a user over a network over multiple sessions or multiple transactions.

### BACKGROUND OF THE INVENTION

Email or webpage interviews or surveys may be sent to internet-connected user for various purposes. For example, a survey for may be sent to a user for market research purposes. As another example, an interview may be sent to a user to have the user rate his music collection, rate his favorite restaurants, or the like. Such an interview may be used for personalization purposes, for example, to provide better recommendations for the user. These interviews typically require a user to be at an internet-connected computer and to take a dedicated period of time to complete the input task.

### BRIEF DESCRIPTION OF THE DRAWINGS

Non-limiting and non-exhaustive embodiments of the present invention are described with reference to the following drawings, in which:

FIG. 1 shows a block diagram of an embodiment of a system for communicating over a network;

FIG. 2 illustrates a block diagram of one embodiment of a client device that may be included in a system implementing an embodiment of the invention;

FIG. 3 shows a block diagram of one embodiment of a network device that may be included in a system implementing an embodiment of the invention;

FIG. 4 illustrates an embodiment of a process according to one embodiment of the invention;

FIG. 5 illustrates a functional block diagram an embodiment of the system of FIG. 1 according to one embodiment of the invention;

FIG. 6 shows a functional block diagram of an embodiment of a portion of the system of FIG. 5 according to one embodiment of the invention;

FIG. 7 illustrates a functional block diagram of an embodiment of another portion of the system of FIG. 5 according to one embodiment of the invention;

FIG. 8 shows a flowchart of an embodiment of another process according to one embodiment of the invention; and

FIG. 9 shows a flowchart of an embodiment of yet another process, in accordance with aspects of the present invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated, the invention is related to a mobile profiling engine. The mobile profiling engine includes an interview manager which assembles an extended interview, and partitions the extended interview into a number of discrete response tasks. The users provide contact information, including time availability. The interview is administered to the user, through their internet or SMS-enabled mobile device, over multiple sessions or multiple transactions, scheduled based on the time availability indicated by the user.

### Illustrative Operating Environment

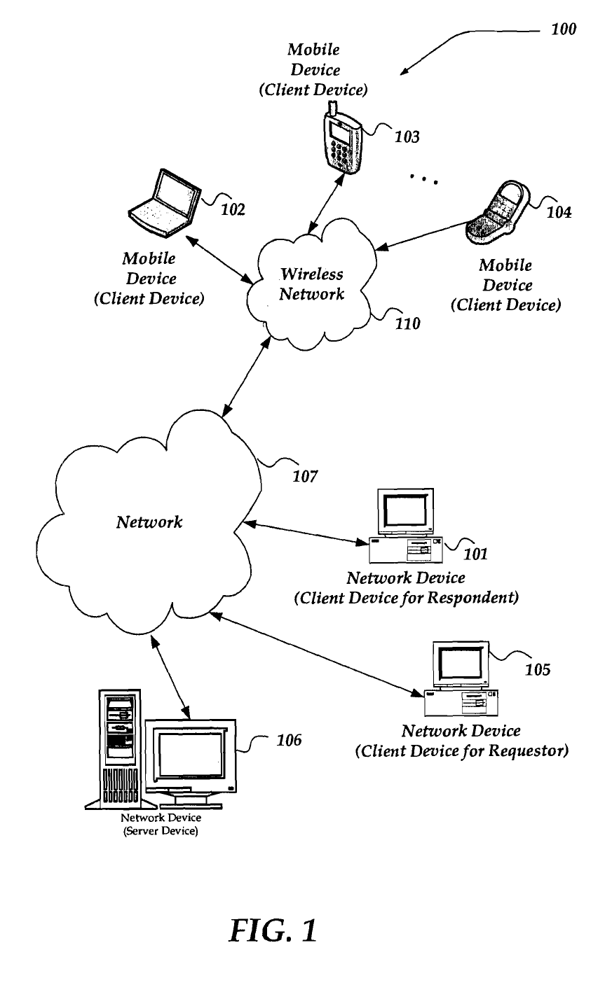

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes network 107, wireless network 110, network device (server device) 106, mobile devices (client devices) 102-104, network device (client device for respondent 101), and network devices (client device for requester 105). In some embodiments, the client device for the respondent may be a mobile device such as mobile devices 102-104. Similarly, the client device for the respondent may be a mobile device such as mobile devices 102-104.

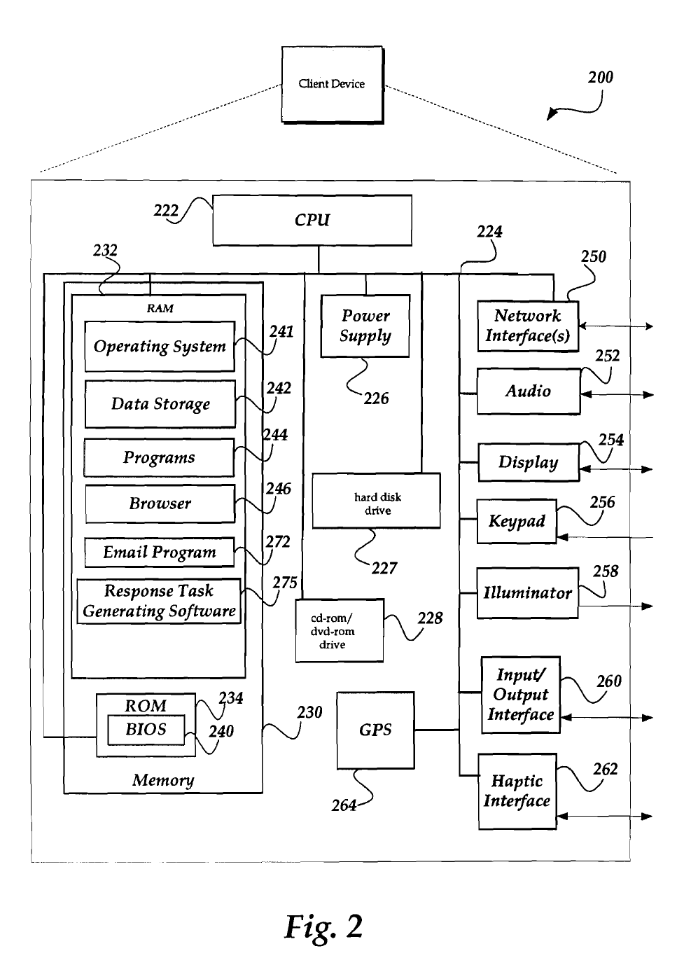

One embodiment of client devices 101-105 is described in more detail below in conjunction with FIG. 2. Generally, however, mobile devices 102-104 may include virtually any portable computing device capable of receiving and sending a message over a network, such as network 107, wireless network 110, or the like. One or more of mobiles devices 102-104 may be used a client device for the respondent, in addition to or instead of network device 101. Similarly, one or more of mobiles devices 102-104 may be used a client device for the requester, in addition to or instead of network device 105. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to server device 106, client device 101, or other computing devices. Moreover, mobile devices 102-104 may further provide information associated with its physical location to another computing device.

Mobile devices 102-104 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as server device 106, client device 101, or the like. However, the present invention is not limited to these message protocols, and virtually any other message protocol may be employed.

Mobile devices 102-104 may be further configured to enable a user to participate in communications sessions, such as IM sessions. As such, mobile devices 102-104 may include a client application that is configured to manage various actions on behalf of the client device. For example, the client application may enable a user to interact with the browser application, email application, IM applications, SMS application, and the like.

Client device 101 and client device 105 may each include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Moreover, client device 101, although representing a computing device that is non-mobile, may be configured to perform many of the actions described above for mobile devices 102-104. In addition, in at least one embodiment, client device 101 may also provide information, such as a MAC address, IP address, or the like, useable to determine its physical location.

Wireless network 110 is configured to couple mobile devices 102-104 and its components with network 107. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 107 is configured to couple server device 106 and its components with other computing devices, including, mobile devices 102-104, client device 101, client device 105, and through wireless network 110 to mobile devices 102-104. Network 107 is enabled to employ any form of computer readable media for communicating information from one electronic device to another. Also, network 107 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 107 includes any communication method by which information may travel between server device 106, client device 101, and other computing devices.

Additionally, communication media typically embodies computer-readable instructions, data structures, program modules, or other data in a modulated data signal such as a carrier wave, data signal, or other transport mechanism and includes any information delivery media. The terms “propagated signal”, “modulated data signal”, and “carrier-wave signal” each include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Although FIG. 1 illustrates server device 106 as a single computing device, the invention is not so limited. For example, one or more functions of server device 106 may be distributed across one or more distinct computing devices.

In one embodiment, server device 106 includes an interview manager. In one embodiment, the interview manager assembles interview task responses, tracks completions of the interview task responses and schedules queries according to user preferences, requestor schedule, and/or the like.

In one embodiment, the client device for the requestor (e.g. client device 105, 102, 103, or 104) is configured to provide a set of queries for individual users and/or cross-sections of users. In one embodiment, server device 106 enables the set of interview queries to be portioned into interview packages, where each interview package represents at least a portion of the set of interview queries. The set of interview queries is an interview. The interview may be a survey, a poll, a user profile, a configuration task (such as the scheduling of a digital video recorder), or the like. In one embodiment, server device 106 is arranged to provide an interview package to a client device for the respondent (e.g. client device 101, 102, 103, or 104).

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. As shown in the figure, client device 200 includes a processing unit 222 in communication with a mass memory 230 via a bus 224.

One embodiment of client device 200 also includes a power supply 226, one or more network interfaces 250, an audio interface 252, a display 254, a keypad 256, an illuminator 258, an input/output interface 260, a haptic interface 262, and a global positioning systems (GPS) receiver 264. However, various embodiment of client device 200 may include more or less components than illustrated in FIG. 2. For example, one embodiment of client device 200 does not include illuminator 258, haptic interface 262, or GPS 264. Further, one embodiment of a client device for a requestor includes response task generating software 275, and one embodiment of a client device for a respondent does not. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP (Session Initiated Protocol), RTP (Real-Time Transport Protocol), UMTS (Universal Mobile Telecommunications System), and the like.

Audio interface 252 may be arranged to produce and receive audio signals such as the sound of a human voice, music, or the like. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Client device 200 may further include additional mass storage facilities such as CD-ROM/DVD-ROM drive 228 and hard disk drive 227. Hard disk drive 227 is utilized by client device 200 to store, among other things, application programs, databases, and the like. Additionally, CD-ROM/DVD-ROM drive 228 and hard disk drive 227 may store audio data, or the like.

Keypad 256 may comprise any input device arranged to receive input from a user (e.g. a sender). For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, and the like. Haptic interface 262 may be arranged to provide tactile feedback to a user (e.g. a sender) of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS and the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include an interface with a Java virtual machine module that enables control of hardware components and/or operating system operations via Java application programs.

In one embodiment, operating system 241 may include specialized digital audio mixing, analog audio mixing, and/or audio playing software. Operating system 241 may provide this software through functional interfaces, APIs, or the like. In one embodiment, digital audio mixing may include generating a new playable data that is based on a plurality of playable data input, where the new data may represent a superposition of the audio signals associated with the plurality of playable data input. Digital audio mixing may be enabled by operating system 241 through an API, such as Windows Driver Media (WDM) mixing APIs and/or digital mixing software libraries, such as Windows' DirectSound, FMOD, Miles Sound System, Open Sound System (OSS), SDL Mixer, CAM (CPU's audio mixer), or the like. In one embodiment, stereophonic (stereo) audio data may be converted into mono-audio data to be played over a mono-audio device, or the like. Similarly, analog audio mixing may be enabled by APIs to convert digital data into an analog signal (e.g. modulation), add and/or filter several analog signals, and re-convert the analog signal into digital data. In one embodiment, the addition and/or filtering may be performed by a summing amplifier.

Memory 230 further includes one or more data storage 242, which can be utilized by client device 200 to store, among other things, programs 244 and/or other data. For example, data storage 242 may also be employed to store information that describes various capabilities of client device 200. The information may then be provided to another device based on any of a variety of events, including being sent as part of a header during a communication, sent upon request, and the like.

In one embodiment, programs 244 may include specialized audio mixing and/or playing software. Programs 244 may provide this software through functional interfaces, APIs, or the like. Programs 244 may also include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, contact managers, task managers, transcoders, database programs, word processing programs, spreadsheet programs, games, CODEC programs, and so forth. In addition, mass memory 230 may store programs such as browser 246, email program 272 and response task generating software 275.

Browser 246 may be configured to receive and to send web pages, web-based messages, and the like. Browser 246 may, for example, receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Client device 200 may also be configured to receive a message from another computing device, employing another mechanism, including, but not limited to email, Short Message Service (SMS), Multimedia Message Service (MMS), internet relay chat (IRC), mIRC, and the like. Client device 200 may use email program 272 or other programs 244 for sending and/or receiving email.

Response task generating software 275 may include software for generating response tasks, which may be subsequently sent to the server device. In one embodiment, a client device for a requestor includes software for generating response tasks. In another embodiment, the server device includes the software for generating response tasks.

### Illustrative Network Device

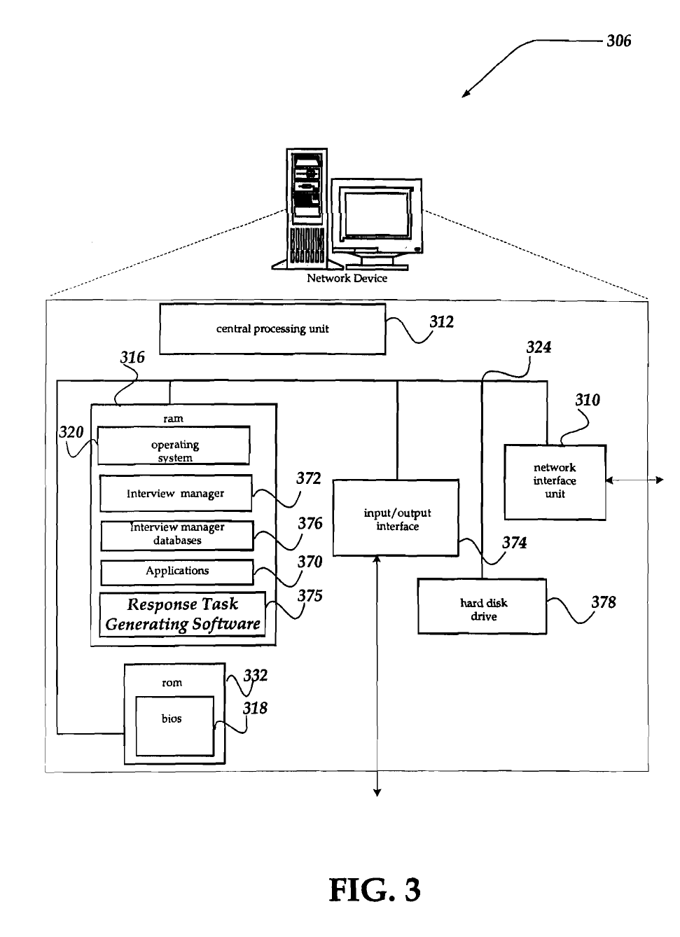

FIG. 3 shows one embodiment of network device 300, according to one embodiment of the invention. Network device 300 may be employed as an embodiment of server device 106 of FIG. 1, and/or the like. Network device 300 may include many more components than those shown. The components shown, however, are sufficient to disclose an illustrative embodiment for practicing the invention.

Network device 300 includes processing unit 312, and a mass memory, all in communication with each other via bus 322. The mass memory generally includes RAM 316, ROM 332, and one or more permanent mass storage devices, such as hard disk drive 378, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, such as network 107 in FIG. 1, via network interface unit 310, which is constructed for use with various communication protocols including the TCP/IP protocol. Network interface unit 310 is sometimes known as a transceiver, transceiving device, network interface card (NIC), and the like.

Network device 300 also includes input/output interface 374 for communicating with external devices, such as a mouse, keyboard, scanner, or other input devices not shown in FIG. 3. Likewise, network device 300 may further include additional mass storage facilities such as a CD-ROM/DVD-ROM drive and hard disk drive 378. Hard disk drive 378 is utilized by network device 300 to store, among other things, application programs, databases, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 370 are loaded into mass memory and run on operating system 320. Examples of application programs include email programs, schedulers, calendars, transcoders, database programs, word processing programs, spreadsheet programs, and so forth.

Response task generating software 375 may include software for generating response tasks. In one embodiment response task generating software 375 includes an online application that a requestor may use to create individual response tasks.

In one embodiment, interview manager 372 assembles interview task responses, tracks completions of the interview task responses and schedules queries according to user preferences, requester schedule, and/or the like. The user preferences may include time availability of the user, and may be stored in interview manager databases 376. In one embodiment, interview manager 372 provides an interview package to a user during the indicated available time, and according to the user's preferred means of contact (e.g. SMS, WAP, email, or the like) to a client device (e.g. 101-105).

In one embodiment, if part of the interview package is uncompleted, interview manager 372 sends the remaining portion of the interview package to the user at a subsequent available time for the user. If the interview package task is completed and there is another interview package available for the user, interview manager 372 sends the next interview package to the user at a subsequent available time for the user.

### Illustrative Process

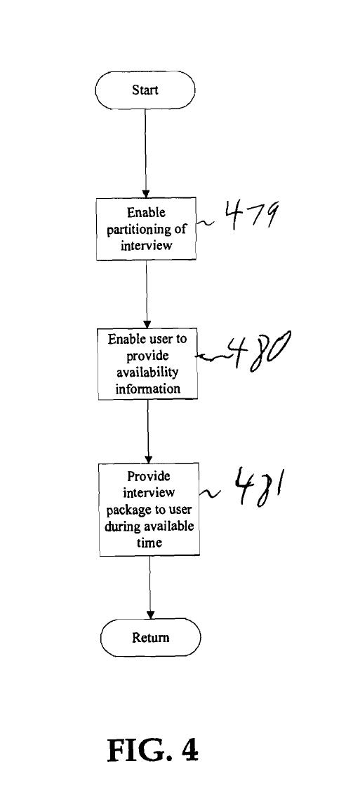

FIG. 4 illustrates an embodiment of process 400, which may be employed by an embodiment of system 100 of FIG. 1. After a start block, the process proceeds to block 479, where the partitioning of an interview into interview packages is enabled, where each interview package is a representation of a subset of the interview. In one embodiment, the interview is partitioned into response tasks, and the response tasks are assembled into interview packages. In this case, even though each interview package may have multiple response tasks, the interview package is still representative of a subset of the complete interview. For example, in one embodiment, the complete interview is relatively long, but each interview package takes a typical user less than 1 minute to complete. Each individual response tasks takes a typical user less than 20 seconds to complete.

The complete interview is a set of interview queries. In one embodiment, the complete interview is an extended survey or poll. In another embodiment, the complete interview is a complete user profile. In one embodiment, the complete interview is the completion of a five minute configuration task. In one embodiment, the complete interview is the complete scheduling of the user's digital video recorder (DVR) for one week. In one embodiment, the complete interview is the rating of a user's entire music collection and/or movie collection. In one embodiment, as an example, the interview package is the rating for four movies in the user's movie collection. In this case, the interview package includes four response tasks, where rating a movie is one response task. In one embodiment, the completion of interviews allows a requestor to build a profile of a user or a cross-section of users.

After block 479, the process proceeds to block 480, where the process enables a user to provide availability information, including windows of time in which the user is available to respond to interview packages. The process then moves to block 481, where the user is provided with an interview package during one of the time windows in which the user indicated that the user is available. In one embodiment, the interview package may be provided by a number of different methods, including but not limited to email, SMS, and WAP, depending on user preferences, and/or the like. The process then advances to the return block, where other processing is resumed.

### Description of One Illustrative Embodiment of a System

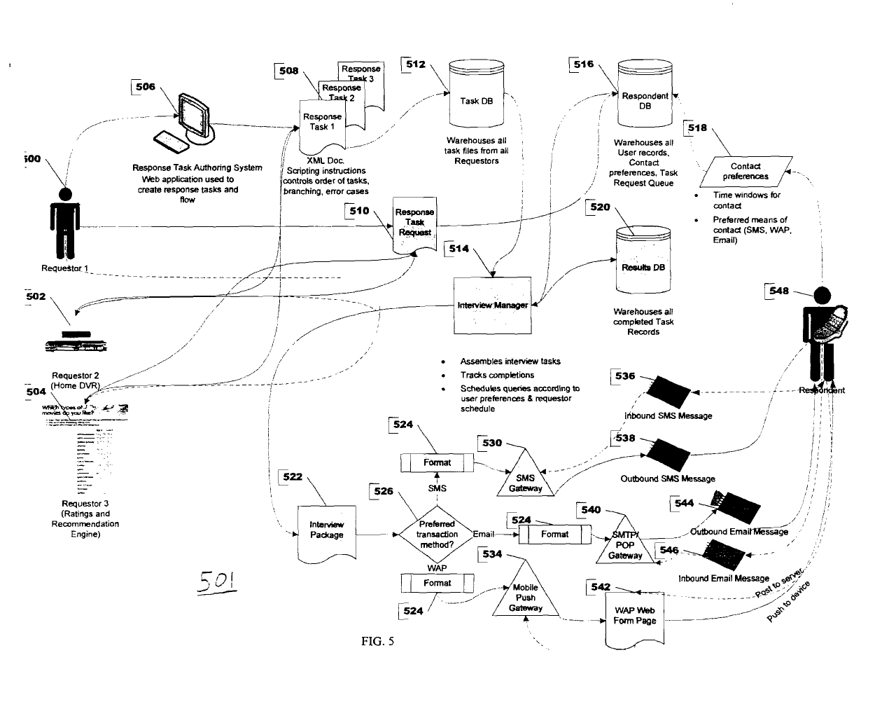

FIG. 5 illustrates a functional block diagram an embodiment of system 501, which may be employed as an embodiment of system 100 of FIG. 1. System 500 may include requester 500, requester 502, requester 504, response task authoring system (RTAS) 506, response tasks 508, response task request 510, task database (DB) 512, interview manager 514, respondent DB 516, contact preferences 518, results DB 520, interview package 522, formatting block 524, preferred transaction determination block 526, SMS gateway 530, mobile push gateway 534, inbound SMS message 536, outbound SMS message 538, SMTP/POP gateway 540, WAP web form page 542, outbound email message 544, inbound email message 546, and respondent 548.

### Illustrative Requestors

A Requestor may be a physical person (e.g. 500), or an internet attached system (e.g. 502, 504) which seeks direct input from an individual user in order to complete specific setup tasks, collect profiling information, or improve recommendations. Requestor 500 may employ a client device (e.g. 102-105 of FIG. 1) to generate response tasks 508 using RTAS 506. An embodiment of response task generating software 375 of FIG. 3 includes RTAS 506. In one embodiment, RTAS 506 is an application on the server device that may be accessed by a client device for the requester online. In another embodiment, RTAS 506 is on the client device for requester 100.

In one embodiment, Response Tasks 508 are formatted XML documents associated with a Unique Identifier that contain respondent instruction, question/task wording, answer choices, and any scripting necessary to manage the interview flow (subsequent questions, error messages, etc.). In other embodiments, response tasks may be formatted in other ways.

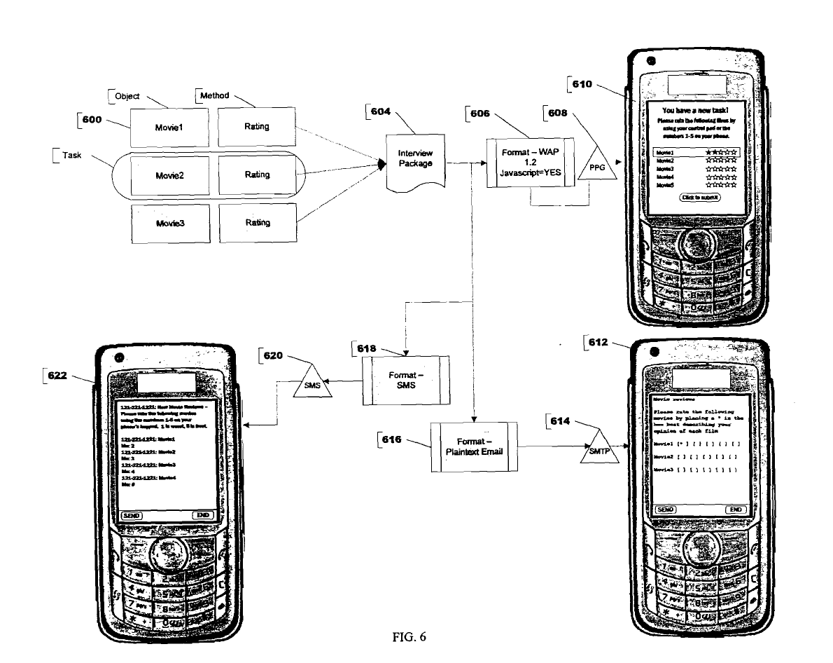

In one embodiment, RTAS 506 also provides a standardized Task Library (e.g. task library 600 of FIG. 6) containing task formats which specify specific interaction patterns optimized for the mobile environment and provide a standardized user experience for the end user, regardless of the task to be completed.

In one embodiment, interview manager 514 or other software compiles Response Tasks 508 from all sources and submits the response tasks to Task DB 512 where they are stored until queried by Interview Manager 514, which manages the bulk of the interview process in one embodiment.

### Illustrative Respondent Database

In one embodiment, Respondent Database (RDB) 516 contains and stores records of individual users who are enrolled in the service. RDB 516 may contains contact preferences, contact information (email address, phone number), specifications of the hardware and agent software used to access the service, demographic and consumer profile information (such as interests in specific consumer categories), and a unique ID. In addition, Respondent Database 516 may store a Response Task Queue for each Respondent.

One possible method of being initiated into the service requires a Respondent (e.g. respondent 548) to enter a phone number or email address in a web page or to send an SMS message to a specified address. A confirmation SMS message is sent to the phone number, or email message is sent to the email address requesting a reply with “Yes” to join the service. Or, the user can simply initiate by sending defined text (e.g. “Yes”) to the service without first receiving an SMS or email. In either case, in this embodiment the SMS is received and parsed for information about the phone. The IMEI/ESN number of the phone corresponds to a database indicating the phone type, carrier, and capabilities, including what kind of messaging and browsing capabilities the phone has. Based upon this information, in this embodiment the user record is updated to indicate the appropriate formatting for this user's device. In turn, this information is reviewed when determining which user may be a Respondent for a given Task (i.e., some Tasks require a richer interface than others, and those with sub-par phones may be eliminated from the prospect pool).

### Illustrative Interview Manager

In addition to passively collected data about device capabilities, in one embodiment Interview Manager 514 collects Contact Preferences 518 for each enrolled user, storing information relating to how and when the user prefers to be contacted with Response Tasks 508. In one embodiment, preference data includes time windows for when users allow the system to present Tasks, the volume of tasks, nature of tasks (personal tasks versus commercial tasks such as survey-taking) and the preferred protocol for the Task transaction (e.g. SMS-based, WAP page-based, or Email based). In one embodiment, a user initiates the process by at an enrollment website in which he provides the contact preferences 518.

In one embodiment, the respondent 548 is inhibited from providing a time window that is smaller than a pre-determined time. For example, in one embodiment, the time window is specified in hours, so that the minimum time window is one hour. In another embodiment, if the user specifies a period of time that is too small, the user will be notified that the time interval is too small and asked to enter time availability information again.

In one embodiment, Interview Manager 514 is middleware that compiles all the interview tasks from the various Requestors, administers the interview to the user, and manages housekeeping tasks necessary to allow the interview to take place over multiple sessions, days, or even weeks.

In one embodiment, interview manager 514 does this by associating a user with a set of tasks. For example, the user profile of a potential Respondent indicates an interest in SUV's, and adventure travel, and states a preference for contact via SMS in the evening hours. Interview manager 514 matches tasks with keywords “adventure travel” and “SUV” where the tasks may be administered via SMS. Tasks may also be assigned directly to a user through a Web Service that enables a Requestor to issue a Response Task Request Document (510) which is stored in the User Record in Respondent DB 516. In this embodiment, the Response Task Request Document contains the Unique ID of the user and the Response Task Unique ID of each Response Task requested.

In this embodiment, such Response Task IDs are placed in a queue associated with the Respondent ID stored in Respondent DB 516. The queue is reviewed periodically by interview manager 514 processor, and when conditions (time) are propitious, a Task is executed.

In one embodiment, based on these preferences, tasks in queue, and the timelines of Requestors, the Interview Manager assembles an Interview Package 522 for each Respondent 548. In one embodiment, the Interview Package includes at least one compiled XML document which contains all the code necessary to render response tasks for a single roundtrip transaction between the system and respondent.

In one embodiment, depending upon the interview protocol selected (526), the Interview Manager 514 formats (524) the Interview Package into an appropriate message format (e.g. SMS Message 538, Email Message 544, WAP Form Page 542, or the like) and sends it to Respondent 548 through SMS Gateway 530, Mobile Push Proxy Gateway 534, SMTP Gateway 440, or the like. Responses from Respondent 548 are collected through the appropriate gateway and handed off to Interview Manager 514 for parsing, processing and recording in Results DB 520.

In one embodiment, interview manager 514 schedules tasks as follows. Each day, for each user, interview manager 514 determines whether there is an interview package available for the user. If so, interview manager 514 schedules interview package 522 to be sent to the user during a time window with which the user would be available that day. Interview manager 514 may also schedule completion of interview packages. If interview package 522 was completed by the user, interview manager 514 stores the results of the tasks in results DB 520. The next day, a new interview task will be schedule for the user during an available time window if there are any more for the user. If the user has not completed interview package 522, interview manager 514 will schedule the same task again during the time window, rather than moving on to a new interview package. If interview package 522 was partially completed by the user, interview manager 514 schedules the remainder of interview package 522 during the time window, rather than moving on to a new interview package, and stores the results of the partially completed interview package in results DB 520.

In one embodiment, interview manager may also perform data validation. For example, if a response task involved rating something from a scale of 0 to 100, and the user entered 500, the response task would not be considered completed, and the user is asked to answer the question again, either immediately or at a subsequent time window.

### Illustrative Results Database

Results Database 520 contains records of Response Tasks completed by users in Respondent DB 516. In one embodiment, Data Records are keyed to the Respondent DB via a unique ID of the Respondent (e.g. 548) who completed the Task, and to Task DB 510 through the unique ID of the Response Task (508) that was completed. These three databases are queried when Requestors (e.g. 500, 502, and 504) extract data from the system.

### Illustrative Respondent

Respondent 548 receives Response Tasks 508 from the service according to the schedule managed by Interview Manager 514. In one embodiment, depending upon the contact preferences set by the Respondent 548 or inferred by the system based on hardware or software specifications of the mobile device registered, the Response Tasks will be issued in either SMS, WAP page-based, or Email format and delivered to the users' SMS client, Email Client, Mobile web browser, or specialized client software written in a device-specific application language (java, flash, symbian, etc.)

### Illustrative Interactions

As previously discussed, depending on, e.g., the contact preferences stated by respondent 518, different means may be used to send response tasks to respondent 548, including such methods as SMS, WAP, and email. Different method of contact may involve different methods of execution for the response task(s), as shown in Table 1 according to one embodiment.

TABLE 1

| Interaction Pattern | WAP 1.1 | SMS |
|---|---|---|
| 1. Single selection | Radio button, dropdown, or list box | Query/Response, answer choices numbered and selected by typing the |
| (Choose One) | with multiple layout options | corresponding number and sending back to server |
| 2. Multiple selection | Check boxes | Query/Response, answer choices numbered and selected by typing the |
| (Choose All That Apply) | | corresponding number(s), delimited with commas for multiple responses |
| 3. Object Rater | Select from 1–5 stars. Stars light up | Query/Response, rating choices are numbered from 1 (worst) to 5 (best) and |
| | on rollover | selected by typing the corresponding number and sending back to server |
| 4. Choose one and specify | Adds other test box(es) to Choose One | 2 stage Query/Response. Answer choice is indicated as in Single selection. |
| | | Verbatim response is collected in a second transaction where the server |
| | | requests user to provide extended text input to explain answer in previous step |
| 5. Choose all that apply | Adds other text box(es) to Choose All | As Multiple Selection (2) interaction, with additional query/response loops for |
| and specify | | each item requiring additional extended text input (as above) |
| 6. Allocation question | Numeric entry, tables, javascript math | Multiple stage query/response where user enters a number from 0–100 in |
| (total sum) | function to display remaining | response to allocation request for first item, is then provided with the next item |
| | points available to allocate | to rate along with a computation of the remaining points availble for allocation |
| | | (100 minus points allocated in step 1). The process is repeated until all items |
| | | have been rated or points allocated. |
| 7. Fill in the blank | Test form box - single line, horizonal | Query response as in ‘Choose one and specify’ (4), above |
| (single/multiple items) | | |
| 8. Fill in the number | Numeric entry or Slider | Query/response as (7) above, with server side validation to limit to numeric |
| (single/multiple items) | | input |
| 9. Essay question | Multi-line text box with scroll bar | Query response as in ‘Choose one and specify’ (4), above |
| 10. Dropdown lists | Dropdown list populated with set of | Query/Response, answer choices numbered and selected by typing the |
| | products, regions, job titles, or other | corresponding number and sending back to server (same as Single Selection |
| | lists specific to Requestor needs | (1), above) |

As shown in Table 1, different interactions patterns for the response tasks may be executed differently in WAP 1.1 than in SMS, as illustrated in Table 1 according to one embodiment.

FIG. 6 illustrates a functional block diagram of an embodiment of an interaction for an embodiment of a portion of system 500 of FIG. 5 according to one embodiment of the invention. The portion includes task library 600, interview package 604, formatting block 606, Push Proxy Gateway (PPG) 608, WAP page load 610, email client 612, SMS client 622, SMTP gateway 614, formatting block 616, formatting block 618, and SMS gateway 620.

If the respondent client device is capable of receiving and processing a WAP form page, the user may receive and provide input to multiple Response Tasks within a single page load (610). A WAP session may be initiated by clicking a link in an SMS message sent to the user by the SMS Gateway, or by a web page which is pushed to the user's browser from Push Proxy Gateway 608 (for handsets that support WAP push), or alerted by a special-purpose application that is resident on the user's phone to enable this type of WAP push (again, from Push Proxy Gateway 608).

The user provides this input using the standard interface controls specified by the mobile device's WAP or mini-browser. After providing input, the user submits the data back to the WAP server, which in turn hands off the data to interview manager 514, which in turn passes the data to specified downstream applications. Interview manager 514 will then step through the rest of the interview, as specified by Interview Package 604. If a user does not want to complete the entirety of the interview package, they may simply close their browser, or click the “No more’ link at the bottom of every interview WAP page. When this occurs, interview manager 514 will re-query the user at the next scheduled interview time, as specified in the Contact Preferences (614) for that user.

If the user elects to be contacted via SMS, Interview Manager 514 formats (618) the interview package into a series of query/response tasks where data is collected one data point at a time (622), delivered through SMS gateway 620.

If the user elects to be contacted via email, the entire Interview Package 604 is formatted into a single email message which is then sent via SMTP server 614 to the users' email client 612. The user replies to an automatically generated reply-to address and marks up certain parts of the email with the required input. The user then sends the email message back to a dedicated mail server which collects responses, parses the data contained in the email, and logs this to the user record based on a unique ID which is contained in the e-mail's header.

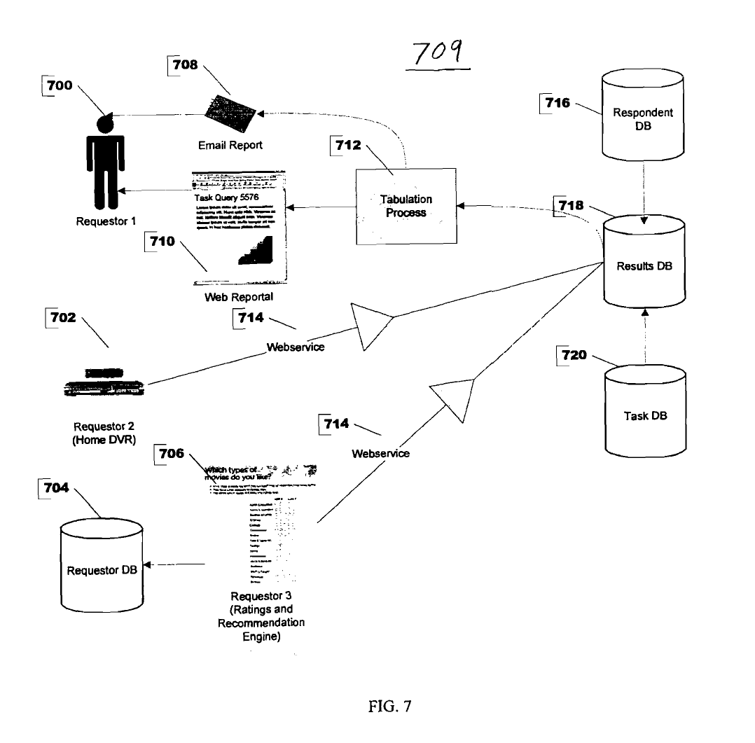

FIG. 7 shows a functional block diagram of an embodiment of a portion 709 of system 500 of FIG. 5 according to one embodiment of the invention. Portion 709 includes requester 700, requestor 702, requester 706, requester DB 704, email report 708, task query 710, tabulation process 712, web service 714, respondent DB 716, results DB 718, and task DB 720.

In one embodiment, Requestors (e.g. 700, 702, and 706) may retrieve data from the service in several ways, including, for example:

1. Through an emailed report (708) which is delivered periodically (daily, weekly, etc.) or upon completion of a set quota of respondents or response tasks. This report shows individual responses to tasks in a tabular format plus an aggregated summary.

2. Through a Website (710) that the Requestor may log into periodically to review results.

3. A combination of the above, with alerts to Requestors that new responses have been received.

4. Through a Web service (714), where the Requestor may retrieve data associated from completed Tasks by querying Results DB 718 by Task ID or by User ID. Such data may then be incorporated in external databases (e.g. requestor database 704) furnished by Requestor 706.

The nature of the report may depend on the type of question. For example, for some questions, such as a rating, the report could indicate the average results for all users, or the like. However, an average result may not be applicable for some questions.

Payment models for the response management services may be accomplished in different ways in different embodiments. The service may support payment transfers in exchange for the provision of personal data, or for the collection of aggregate data. Requestors may pay to set up a Response Task, or pay when the task has been responded to, or when a set quota of completed Response Tasks has been reached. In another model, the Requestor may pay a lead-generation fee if a User has agreed to receive marketing information from a Requestor. Another form of payment may be in the form of discounts for products or services. These may be provided by the Requestors or by the operator of the service.

In one embodiment, information from participants in the service may be aggregated in a large centralized database and offered to other parties, including those who may not be Requestors. In one embodiment, requesters who agree to the inclusion of “their” responses in such an aggregate database may receive discounts to fees otherwise payable. In this way, the system supports either privately managed market information gathering, or collaborative development of market knowledge.

Response tasks may be generated to gain information from a cross-section of people. In one embodiment, such a cross-section may be determined by an intermediary (not shown). For example, a requestor could have an interview that he would like answered by 1000 people that are men between the ages of 25 and 35. The intermediary could then, in communication with the respondent DB, randomly select 1000 people who meet that criteria, and then indicate those user IDs to the Interview Manager.

In one embodiment, in addition to receiving interview packages as scheduled by the interview manger, a user may ask whether there are any interview packages for him, and if so, request that the interview package be sent to him immediately. For example, a user may have small intervals of time, such as waiting in line, or waiting for a bus, with which to complete an interview package. Such small period of time may be insufficient to complete an entire interview, but since the interview has been divided into interview packages, in which each interview package takes a relatively small period of time to complete, the user is able to make use of these small periods of time to complete a portion of an extended task.

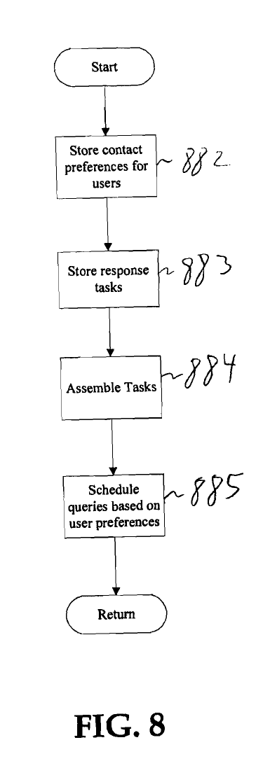

FIG. 8 shows a flowchart of an embodiment of process 800. After a start block, the process proceeds to block 882, where contact preferences for users are stored. As discussed above, the contact preferences may include preferred means of contact (e.g. SMS, WAP, email, or the like), time windows for contacting the user, and/or the like. The process then moves to block 883, where response tasks are stored. In one embodiment, the response tasks are stored in task DB 512 of FIG. 5. The process then advances to block 884, where tasks are assembled. The process then proceeds to block 885, where queries are scheduled based on user preferences. The process then moves to a return block, where other processing is resumed.

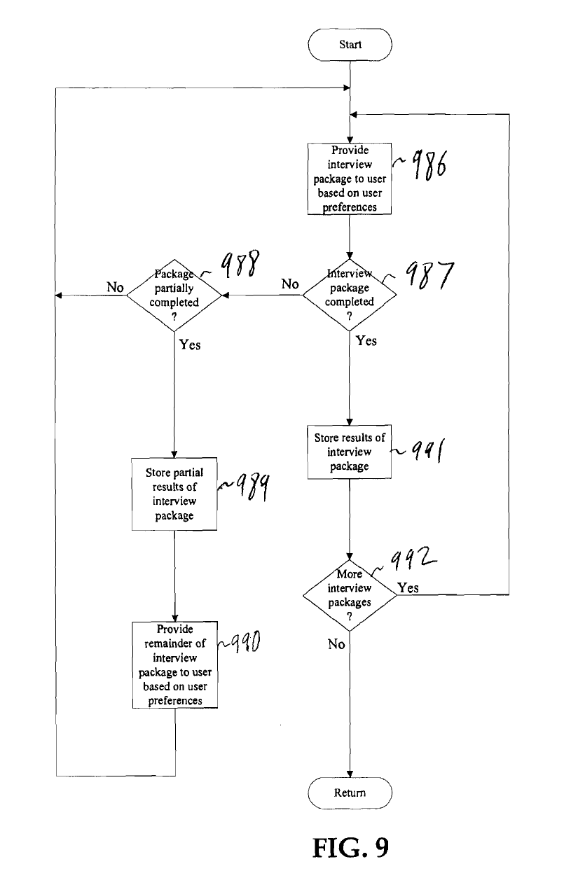

FIG. 9 shows a flowchart of an embodiment of process 900. After a start block, the process moves to block 986, where an interview package is provided to the user based on user preferences. For examples, the interview package may be provided using the means of contact (e.g. SMS, WAP, email, or the like), and in a time window the user has previously given for contacting the user. The process then advances to decision block 987, where a determination is made as to whether the user has completed the interview package. If not, the process proceeds to decision block 988, where a determination is made as to whether the interview package is partially completed. If not, the process moves to block 986.

If the determination at decision block 988 is positive, the process advances to block 989, where the partial results of the interview package are stored. The process then proceeds to block 990, where the remainder of the interview package is provided to the user based on the user preferences. For example, the remainder of the interview package may be provided at the next time window, or in one of the time windows in the next day, as discussed above. The process then proceeds to block 986.

At decision block 987, if the determination is positive, the process moves to block 991, where the results of the interview package are stored. The process then advances to decision block 992, where a determination is made as to whether there are more interview packages for the user. If so, the process moves to block 986, where the next interview package is provided to the user based on user preferences. For example, the interview package may be provided at the next time window, or in one of the time windows in the next day, as discussed above.

At decision block 992, if the determination is negative, the process moves to a return block, where other processing is resumed.

The above specification, examples, and data provide a complete description of the manufacture and use of the composition of the invention. Since many embodiments of the invention can be made without departing from the spirit and scope of the invention, the invention also resides in the claims hereinafter appended.

What is claimed is:

1. A method for managing interview information, comprising:
enabling a set of interview queries to be partitioned into a plurality of interview packages, wherein each of the plurality of interview packages represents at least a portion of the set of interview queries;
enabling a user to provide availability information including a set of time intervals in which the user is available to answer interview packages;
during the set of time intervals, providing one of the plurality of interview packages to the user over a network; and
if the provided interview package is completed by the user, providing another of the plurality of interview packages to the user during a subsequent time interval in the set of time intervals.

2. The method of claim 1, further comprising:
if a portion of the provided interview package is uncompleted, providing the user with the remaining portion of the interview package at a subsequent time interval in the set of time intervals.

3. The method of claim 1, wherein enabling the user to provide availability information including the set of time intervals is accomplished such that the user is inhibited from providing a time interval that is less than a minimum determined time.

4. The method of claim 1, wherein the set of interview queries is at least one of: a user profile, a configuration task, a survey, a poll, or rating of a collection.

5. The method of claim 1, wherein each interview package is sufficiently short so as to take a typical user less than two minutes to complete.

6. The method of claim 1, wherein
enabling a set of interview queries to be partitioned into a plurality of interview packages includes:
enabling a plurality of response tasks to be created, wherein each response task represents to one query of the set of interview queries; and
assembling the response tasks into interview packages.

7. The method of claim 1, wherein
providing one of the plurality of interview packages to the user includes:
determining which format of a plurality of formats the interview package should be sent to the user with;
formatting the interview package to the user in the determined format;
sending the interview package to the user based on the determined format.

8. The method of claim 7, wherein the plurality of formats include at least two of email, Wireless Access Protocol (WAP), or Short Message Service (SMS).

9. The method of claim 7, further comprising:
enabling the user to provide a preferred format of the plurality of formats for contacting the user, wherein determining which format of the plurality of formats the interview package should be sent to the user with includes selecting the preferred format provided by the user as the determined format.

10. A network device for managing interview information, comprising:
a memory component for storing data; and
a processing component that is arranged to execute data that enables actions, including:
enabling a set of interview queries to be partitioned into a plurality of interview packages, wherein each of the plurality of interview packages represents at least a portion of the set of interview queries;
enabling a user to provide availability information including a set of time intervals in which the user is available to answer interview packages;
during the set of time intervals, providing one of the plurality of interview packages to the user over a network; and
if the provided interview package is completed by the user, providing another of the plurality of interview packages to the user during a subsequent time interval in the set of time intervals.

11. The network device of claim 10, wherein the processing component is arranged to enable further actions, including:
if a portion of the provided interview package is uncompleted, providing the user with the remaining portion of the interview package at a subsequent time interval in the set of time intervals.

12. The network device of claim 10, wherein the set of interview queries is at least one of: a user profile, a configuration task, a survey, a poll, or rating of a collection.

13. A mobile device for managing interview information, comprising:
a transceiver that is arranged to receive and transmit information on a network through at least a wireless interface; and
a processor that is arranged to communicate with the transceiver, wherein the processor is arranged to execute data that enables actions, including:
enabling a set of interview queries to be partitioned into a plurality of interview packages, wherein each of the plurality of interview packages represents at least a portion of the set of interview queries;
providing availability information including a set of time intervals in which the user is available to answer interview packages;
during the set of time intervals, receiving one of a plurality of interview packages over a network, wherein the interview package is one of a plurality of interview packages, and wherein each of the plurality of interview packages represents at least a portion of a set of interview queries; and
if the provided interview package is completed by the user, receiving another of the plurality of interview packages during a subsequent time interval in the set of time intervals.

14. The mobile device of claim 13, wherein the set of interview queries is at least one of: a user profile, a configuration task, a survey, a poll, or rating of a collection.

15. A processor-readable medium having processor-executable code stored therein, which when executed by one or more processors, enables actions, comprising:
enabling a set of interview queries to be partitioned into a plurality of interview packages, wherein each of the plurality of interview packages represents at least a portion of the set of interview queries;
enabling a user to provide availability information including a set of time intervals in which the user is available to answer interview packages;
during the set of time intervals, providing one of the plurality of interview packages to the user over a network; and
if the provided interview package is completed by the user, providing another of the plurality of interview packages to the user during a subsequent time interval in the set of time intervals.

16. The processor-readable medium of claim 15, enabling further actions, including:
if a portion of the provided interview package is uncompleted, providing the user with the remaining portion of the interview package at a subsequent time interval in the set of time intervals.

17. The processor-readable medium of claim 15, wherein the set of interview queries is at least one of: a user profile, a configuration task, a survey, a poll, or rating of a collection.

18. A system for communicating over a network for managing interview information, comprising:
a client device and a system device, wherein the client device and system device are arranged to communicate over a network, and to operate in conjunction with each other to perform actions, including:
enabling a set of interview queries to be partitioned into a plurality of interview packages, wherein each of the plurality of interview packages represents at least a portion of the set of interview queries;
enabling a user to provide availability information including a set of time intervals in which the user is available to answer interview packages;
during the set of time intervals, providing one of the plurality of interview packages to the user over a network; and
if the provided interview package is completed by the user, providing another of the plurality of interview packages to the user during a subsequent time interval in the set of time intervals.

19. The system of claim 18, wherein the client device and system device operate in conjunction to provide further actions, including:
if a portion of the provided interview package is uncompleted, providing the user with the remaining portion of the interview package at a subsequent time interval in the set of time intervals.

20. The system of claim 18, wherein the set of interview queries is at least one of: a user profile, a configuration task, a survey, a poll, or rating of a collection.
